(19) United States
(12) Patent Application Publication
(10) Pub. No.: US 2005/0206219 A1
(43) Pub. Date: Sep. 22, 2005

(54) Wheel design

(76) Inventor: Peter J. Johnson, Desoto, TX (US)

Correspondence Address: GRADY K. BERGEN, 3333 LEE PARKWAY, SUITE 600, DALLAS, TX, 75219, US

(21) Appl. No.: 10/802,005

(22) Filed: Mar. 16, 2004

(51) Int. Cl. B60B 7/06

(52) U.S. Cl. 301/37.35

(57) ABSTRACT

A wheel for an automotive vehicle has a hub for mounting to an axle of the automotive vehicle. A rim is disposed radially outward from the hub and being configured for receiving a tire. A support structure extends between the hub and the rim. The hub, rim and support structure each have an outer face. The outer face of at least one of the hub, rim and support structure has formed thereon monetary indicia.

### TECHNICAL FIELD

The invention relates to wheels for automotive vehicles.

### BRIEF DESCRIPTION OF THE DRAWINGS

For a more complete understanding of the present invention, reference is now made to the following descriptions taken in conjunction with the accompanying figures, in which:

FIG. 1 is a perspective view of a wheel and tire of an automotive vehicle;

FIG. 2 is a front perspective view of the wheel of FIG. 1, shown without the tire;

FIG. 3 is a perspective view of a wheel, shown with a hub plate exploded away;

FIG. 4 is a front elevational view of another embodiment of a wheel;

FIG. 5 is a front elevational view of still another embodiment of a wheel;

FIG. 6 is a front perspective view of another embodiment of a wheel;

FIG. 7 is front elevational view of another embodiment of a wheel;

FIG. 8 is a front perspective view of another embodiment of a wheel;

FIG. 9 is a front elevational view of another embodiment of a wheel;

FIG. 10 is a front perspective view of another embodiment of a wheel;

FIG. 11 is a front elevational view of another embodiment of a wheel;

FIG. 13 is a front perspective view of another embodiment of a wheel;

FIG. 14 is a front perspective view of another embodiment of a wheel;

FIG. 15 is a front perspective view of another embodiment of a wheel;

FIG. 16 is a front elevational view of another embodiment of a wheel; and

FIG. 17 is a front elevational view of another embodiment of a wheel.

### DETAILED DESCRIPTION

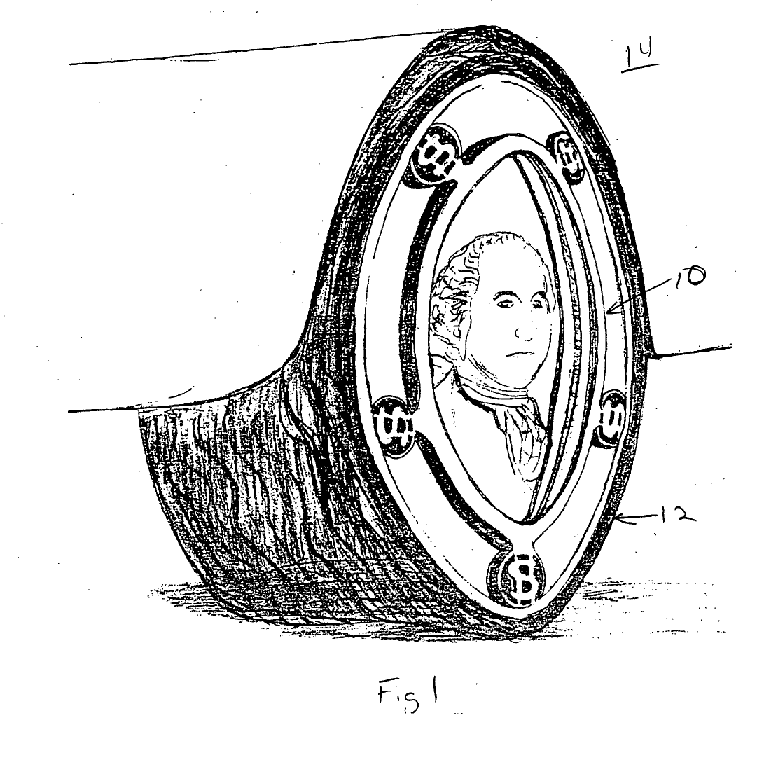

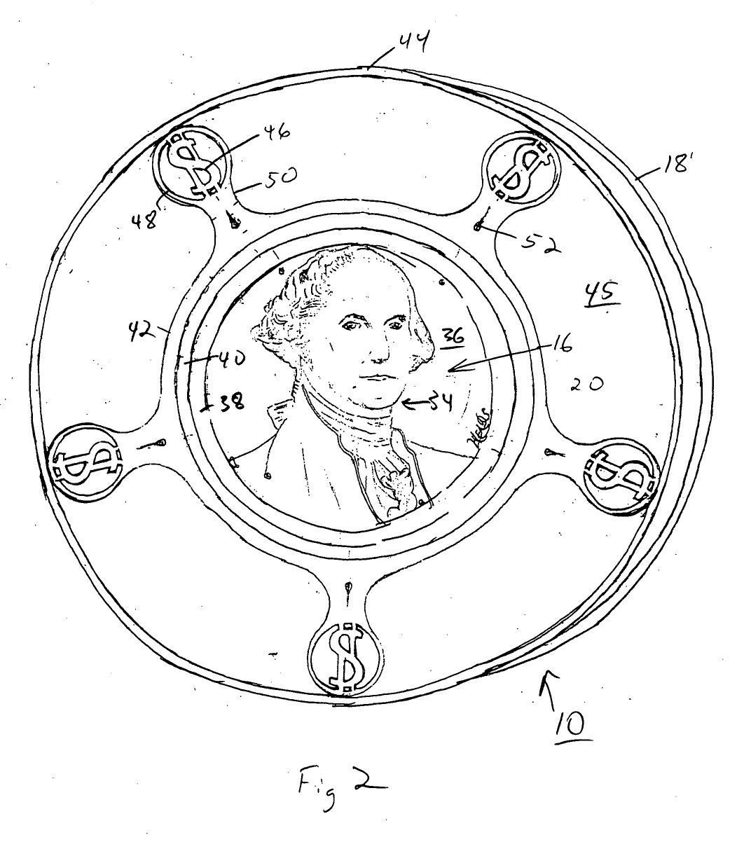

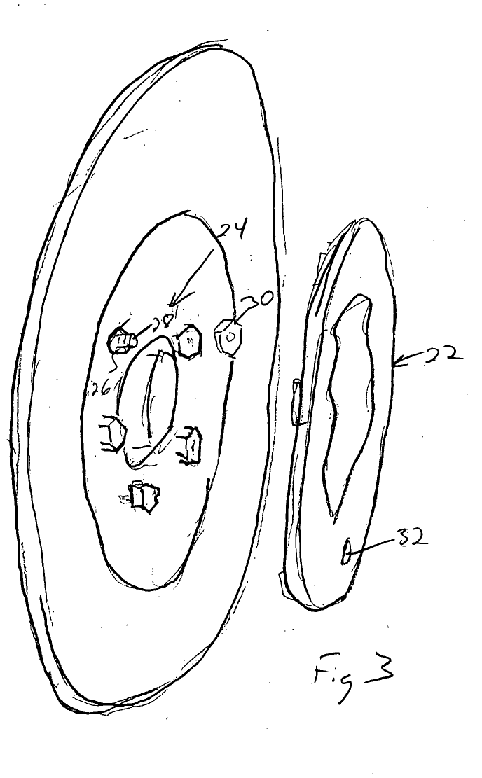

Referring to FIG. 1, a wheel 10 and tire 12 assembly for an automobile 14 is shown. FIG. 2 illustrates the wheel 10 with the tire removed. The wheel 10 is typically constructed of steel or aluminum, or an alloy of such or similar metals or other suitable materials. The wheel 10 includes a central hub or hub portion 16 for mounting to an axle of the automobile. A circumferential rim 18 is disposed radially outward from the hub 16, and is configured for receiving a tire, such as the tire 12, which is mounted thereon.

A support structure 20 extends radially outward from the hub 16 to the rim 18 for supporting the rim 18 and tire 12. The support structure 20 may be in the form of circumferentially spaced apart spokes extending radially from the hub 16 to the rim 18. Alternatively, the support structure 20 may be a generally continuous or non-continuous, spokeless structure that extends circumferentially around the hub 16, and extends radially outward to the rim 18. The spokeless support structures may also have various shaped holes, apertures or open areas.

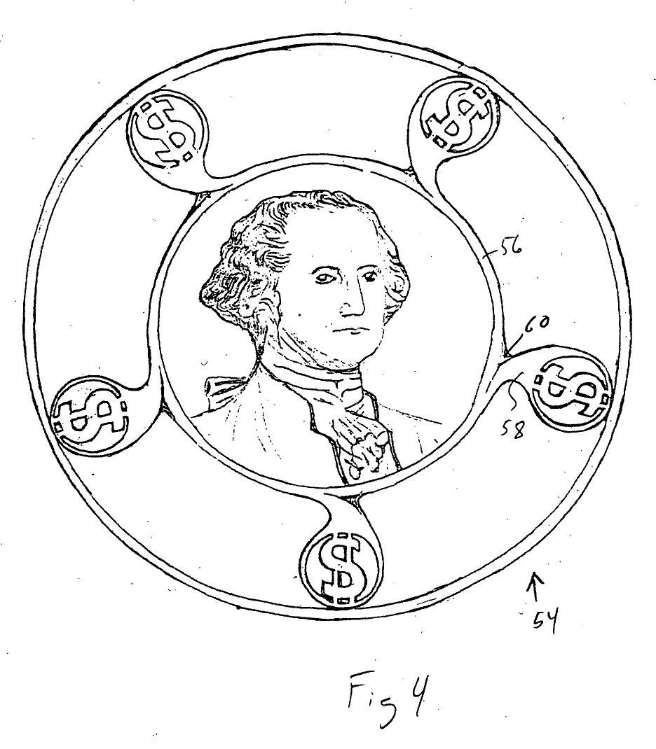

Referring to FIG. 3, the hub 16 may include a detachable hub plate 22 that can be removed to access a hub mounting portion 24 for mounting the wheel to the automobile axle. The hub mounting portion 24 is typically provided with a plurality of circumferentially spaced apertures, such as the aperture 26, for receiving lugs 28 provided on the axle of the automobile or vehicle to which it is mounted in a conventional manner. Lug nuts 30 are used to secure the wheel 10 upon the axle. The hub plate 22 is provided to generally cover the mounting portion 24 and to provide continuity to the outer or front face of the wheel 10, as will be discussed in more detail further on. The hub plate 22 may also be provided with a lock 32, such as a key lock, to prevent removal or theft of the wheel after it has been mounted to the vehicle axle. In certain embodiments, the mounting portion 24 of the wheel may be exposed so that no hub plate is required.

The wheels of the present invention have formed on the outer or front face decorative features in the form of various monetary indicia. As used herein with respect to the monetary indicia being formed on the outer face of the wheel, the expression “formed” means that it is permanently fixed or is an integral part of the wheel itself, and is not merely positioned thereon in a temporary manner, such as might occur with advertising, pricing or product packaging that is intended to be removed from the wheel at some point in time. The monetary indicia may be so formed by etching, engraving, casting, molding, embossing, imprinting, stamping, coating or any other method suitable for forming an image on the wheel. In particular embodiments, the monetary indicia or portions thereof are three-dimensional or contoured, having variations in depth from the outermost or innermost surfaces of the wheel and may provide a sculpted, such as in relief sculpture, carved or engraved appearance.

The outer or front face of the wheel may be provided with a shiny or matt finish and may be of any color, such as silver, gold, black, white, etc. or combination of two or more colors. In particular embodiments, a chrome finish, commonly used on many custom automobile wheels, is provided on the outer face of the wheel. A stain or variation in color may also be provided on raised or recessed surfaces of the outer face of the wheel. This may be used to enhance contrasts and variations in depths.

As used herein, “monetary indicia” means indicia that is indicative or suggestive of a monetary unit, currency, coinage, or a component thereof. As used herein, a monetary unit may include any numeral or monetary value, whether numeric or verbally written, such as the denominations 1, 5, 10, 20, 25, 50, 100, etc., particularly those that may be commonly used on coins or currency or that may designate a monetary value that is not necessarily a denomination of currency or coinage. Typically, the monetary value will be a whole number. Additionally, as used herein, a monetary unit may include a monetary symbol or designation, such as a dollar sign ($) or cent sign (¢), which are commonly used with United States currency and coins or that are recognizable as being dollar signs or cent signs. A monetary unit may also include the currency symbol of other countries or communities, such as the pound sign (£), euro sign ( [symbol] ), yen sign (¥), franc sign ( [symbol] ), lira sign ( [symbol] ), etc.

The monetary indicia suggestive of currency or coinage may include an entire face or a component or portion thereof of a currency note or coin or a likeness of a currency note or coin. Components of a currency note or coin may include, but are not limited to, a portrait or individual human likeness, a word or words or a phrase, a representation of an architectural structure, geometric shapes or patterns, banners, seals (such as an official seal), representation of leaves, foliage, branches or flowers, and animal representations. These may be substantially identical to those that are found on actual currency notes or coins or that may be suggestive of those found on currency or coins.

With respect to portraits and human likenesses, these may include the likeness of faces or busts of historical or famous leaders or government officials commonly found or perceived to be found on actual currency and coins or that are suggestive of those found on currency or coins. In the U.S., such humans include George Washington, Abraham Lincoln, Thomas Jefferson, Alexander Hamilton, John F. Kennedy, Andrew Jackson, Ulysses S. Grant, Benjamin Franklin, Franklin D. Roosevelt, William McKinley, Grover Cleveland, James Madison, Salmon P. Chase, Woodrow Wilson, Susan B. Anthony and Sacajawea, all of whom appear or appeared on an actual U.S. currency note or coin. The portrait or human likeness may also include a representation of other non-fictional or fictional human figures, such as the composite Native American likeness found on the U.S. “buffalo” or “Indian Head” nickel. Such portraits or likenesses may be included within a frame or border, such as the full or partial circular or oval shape commonly found surrounding portraits on U.S. currency notes or as would be found within the perimeter of a circular or substantially circular coin.

Architectural representations may include representations or likenesses of famous or historical buildings, monuments or structures, or a component or components of these. Such historical monuments or buildings that may be found on currency notes or coins of the U.S. include the Lincoln Memorial, The White House, the U.S. Treasury, the Capital Building, Monticello, Independence Hall or the Statue of Liberty. The architectural representation may also include a likeness of other or fictional buildings, monuments or structures, such as the pyramid and eye structure found on the present-day back face of the U.S. one-dollar currency note.

Animal representations may include a buffalo or eagle, or other bird or animal having national significance or that are suggestive of those found on actual currency notes or coins.

With reference to more specific embodiments, FIG. 2 shows an outer or front face of the wheel 10. Provided on the outer face of the hub 16 and support structure 20 is representation or likeness 34 of a bust of George Washington, which is substantially centered on the hub 16. The likeness 34 may be formed in relief with variations in depth to provide a three-dimensional appearance, with the background or relief plane areas 36 being recessed from the image of George Washington 34. The likeness of George Washington may be similar to that of a present-day U.S. one-dollar currency note. The likeness 34 is surrounded by a circular border of concentric rings 38, 40, 42, which are raised from the background 36 and centered on the hub 16. Each successive ring 38, 40, 42 from the hub 16 is stepped or raised higher than the next adjacent ring. The uppermost extent of each of the rings 38, 40, 42 defines a surface band, which is substantially the same or similar in width as the other rings.

The likeness 34 surrounded by the bordering rings 38, 40, 42 may be contained upon the entire hub 16 or may extend beyond the hub onto the support structure 20. In cases where images, lines or patterns formed on the outer face of the hub extend beyond the extent of the hub plate of a wheel, the hub plate can be positioned or rotated so that the images, lines or patterns are aligned so that they have a continuous or non-misaligned appearance.

On the outer face of the rim 18 of the wheel 10, immediately adjacent to the rim edge, is a raised circumferential rim ring 44, which is concentric with the rings 38, 40, 42 and has a surface band width that is substantially the same as the rings 38, 40, 42. A slightly recessed relief plane 45 is provided between the ring 42 and rim ring 44. The width of the border rings and the rim rings described herein may vary, but a typical width is from 1/8 inch to one inch, with from 1/4 to 5/8 inch being more typical.

Located radially inward from and adjacent to the ring 44 are a plurality of dollar signs 46 that are equally spaced circumferentially apart and which are similar in appearance to one another. As used herein, unless otherwise specified, the term “radial” or “radially” refers to the lines or the radial direction extending or diverging away from the hub or hub center. Five dollar signs are shown, although this number may be less or more. The dollar sign 46 may have a length that is less than one-half of the length of the likeness 34. The dollar signs 46 are oriented so that their longitudinal axes are oriented radially. Each dollar sign 46 is closely surrounded by a circular border ring 48.

A radially extending neck portion 50 merges with the ring 48 at one end and at the other end with the ring 42. The neck 50 has a length that is about the same as the length dollar sign 46 and is narrower in width than the diameter of the ring 48. The neck 50 narrows at its midsection and expands and merges with the border ring 48 and ring 42. The outermost surface of the ring 42, neck 50, border ring 48 and dollar sign 46 are generally continuous so that they have a generally unbroken or uniform surface appearance. Provided in the center of each neck 50 is a tear-dropped shaped indention or dimple 52.

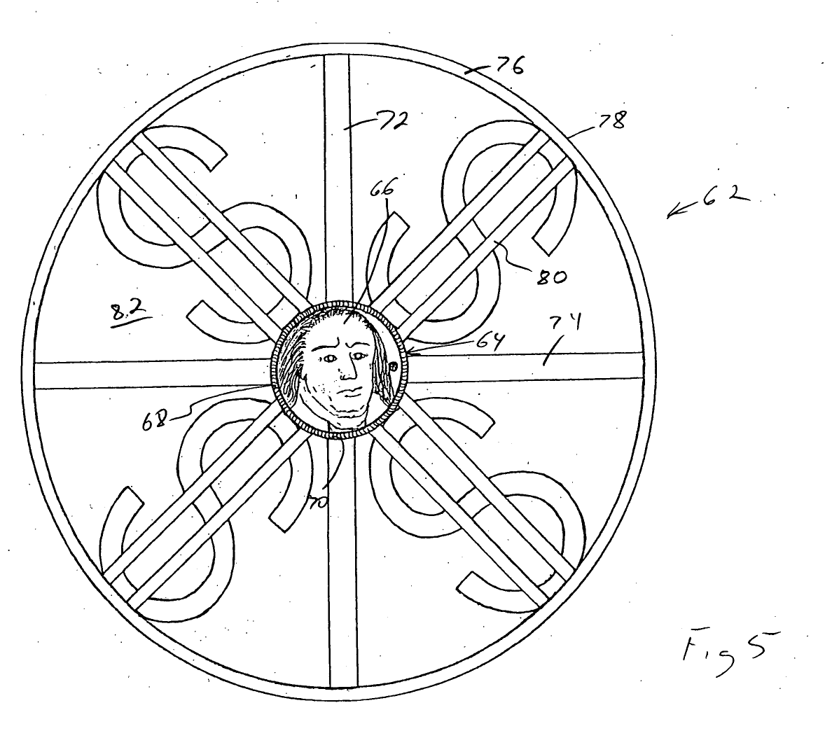

FIG. 4 shows a wheel 54 that is similar to the wheel 10. The wheel 54, however, is provided with only a single border ring 56 surrounding the portrait of George Washington, instead of the stepped rings 38, 40, 42, shown in FIG. 3. Additionally, a “twisted” neck 58 is provided that joins the dollar symbols and ring 56. This is accomplished by providing a recessed or notched area 60 so that surface of the neck 58 smoothly tapers or narrows and turns in the direction opposite the notch 60, as it approaches and merges with the ring 56.

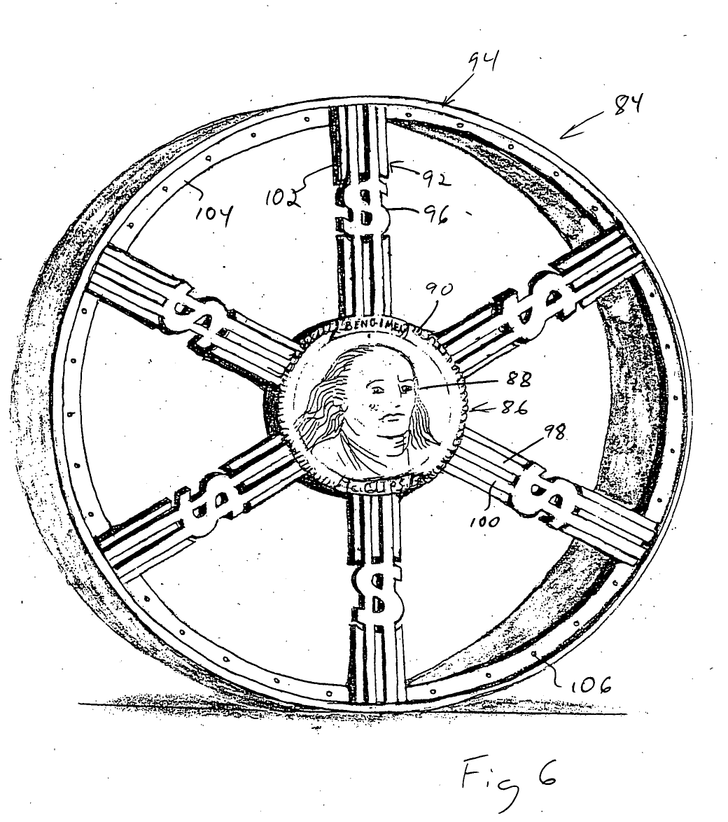

FIG. 5 illustrates a wheel 62 having a hub 64 with a portrait of Benjamin Franklin 66 formed thereon. Closely surrounding the portrait 66 is a circular border ring 68 having closely spaced ridges 70 extending across the width of the surface band of the border ring 68. These may provide an appearance similar or suggestive to the ridges sometimes formed on the edges of coins.

Extending radially outward from the edges of the border ring 68 are perpendicular cross bars 72, 74, generally dividing the outer face of the wheel into quarters. The cross bars 72, 74 intersect a rim ring 76 located along the outer face of the rim 78. Positioned within the center of each of the quarters defined by the cross bars 72, 74 are dollar signs 80. The dollar signs extend outward from the edge of border ring 68 to the rim ring 76, with the longitudinal axis of each dollar sign being generally radially oriented. The length of each dollar sign 80 can be at least one time greater than the diameter of the border ring 76. A background area 82 may be provided as a relief plane with other areas being raised above or recessed below the relief plane. Alternatively, all or a portion of the background area 82 may be open so that the non-open portions serve as spokes, beams or sufficient support structure for supporting the rim and tire.

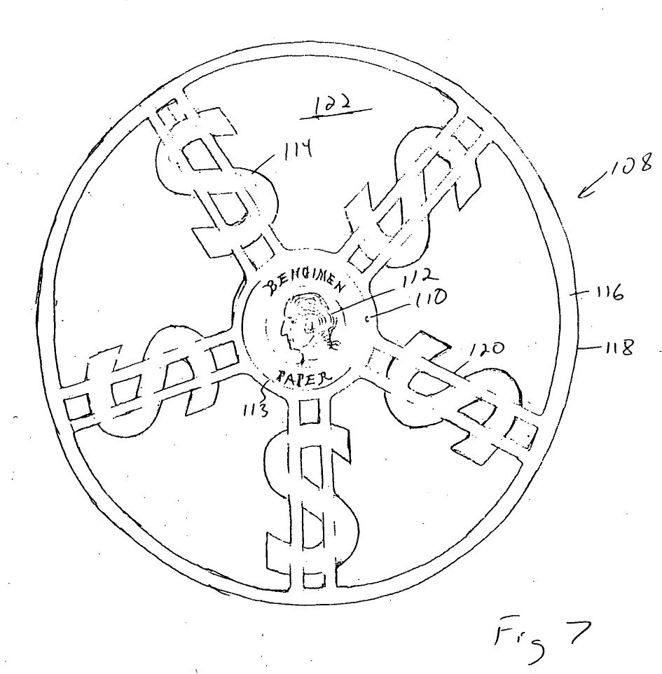

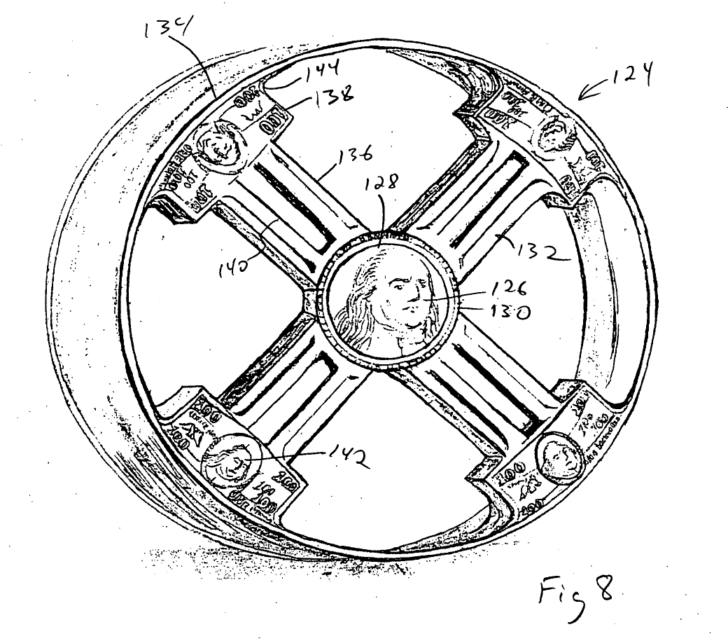

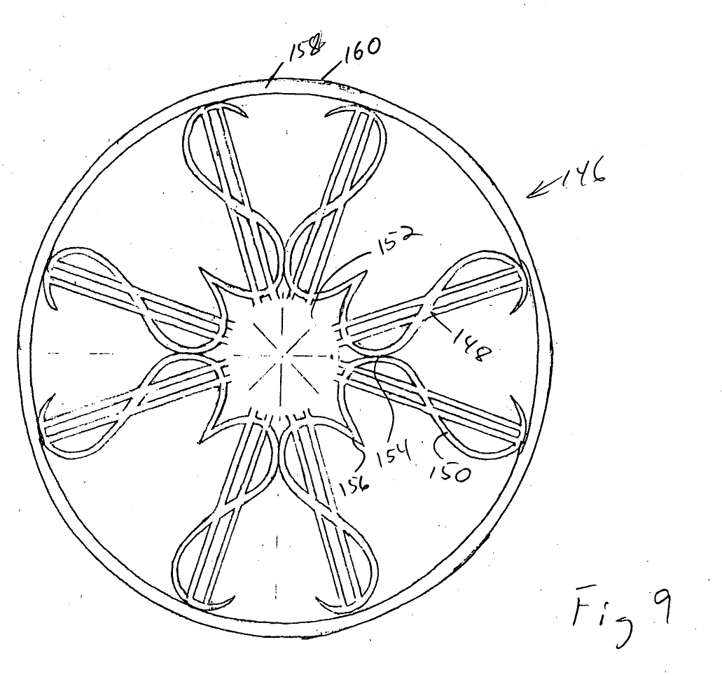

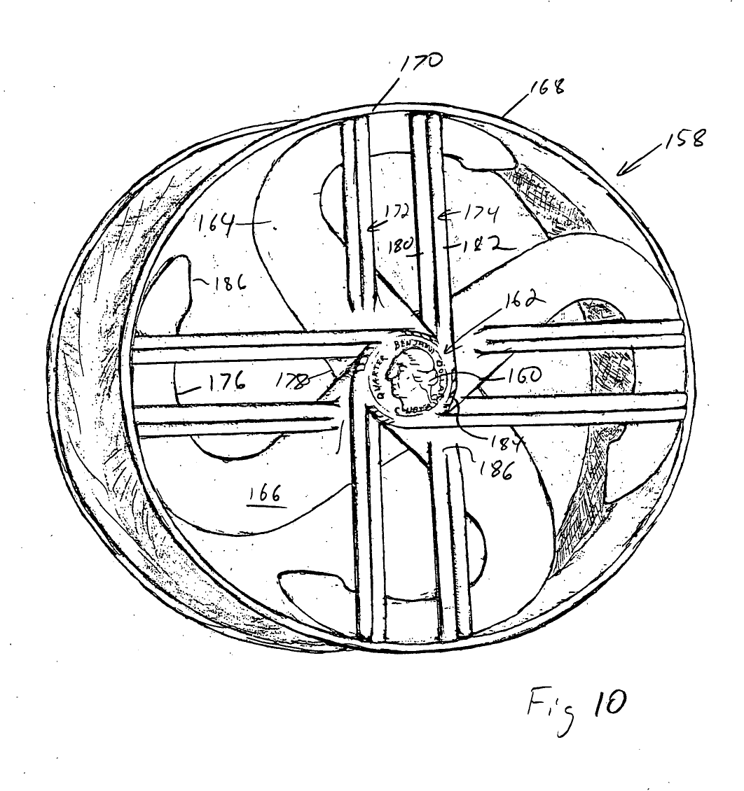

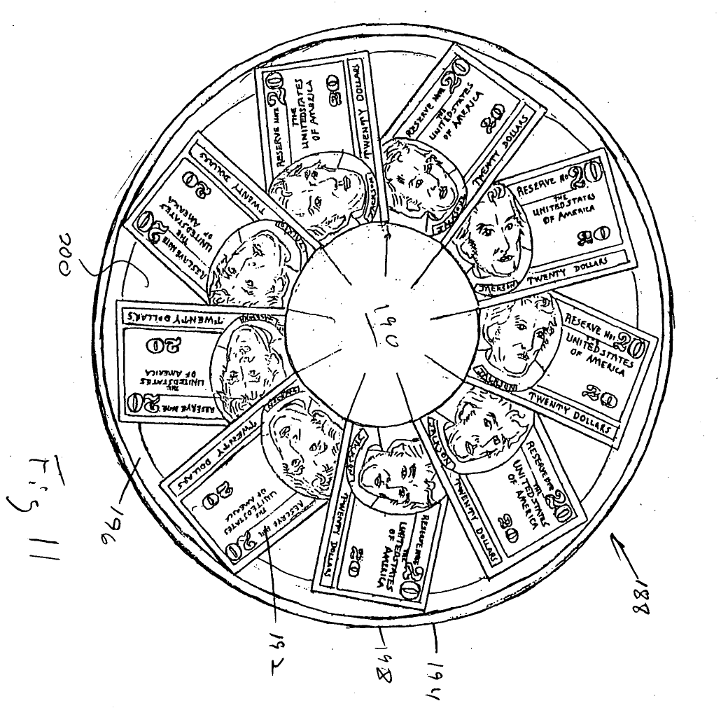

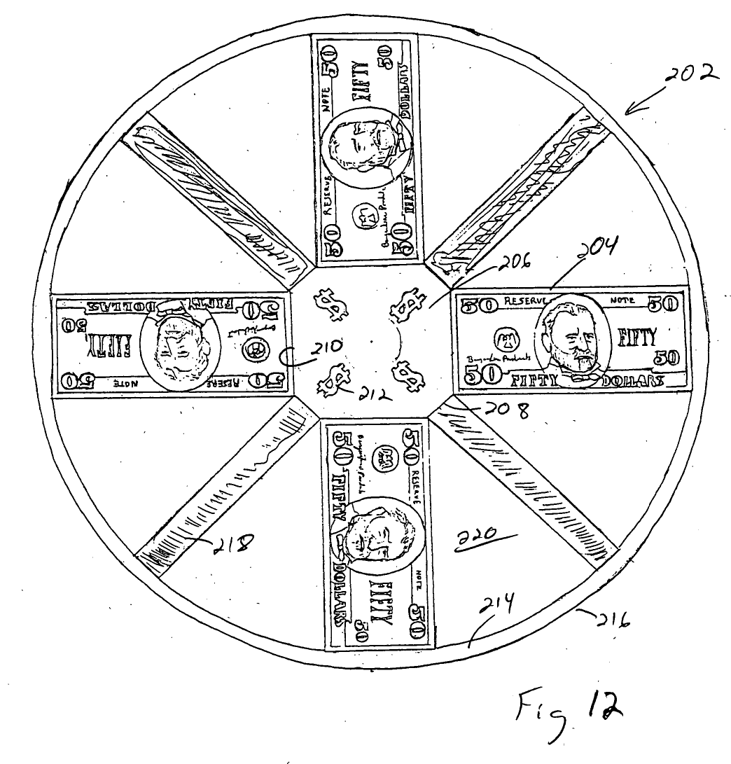

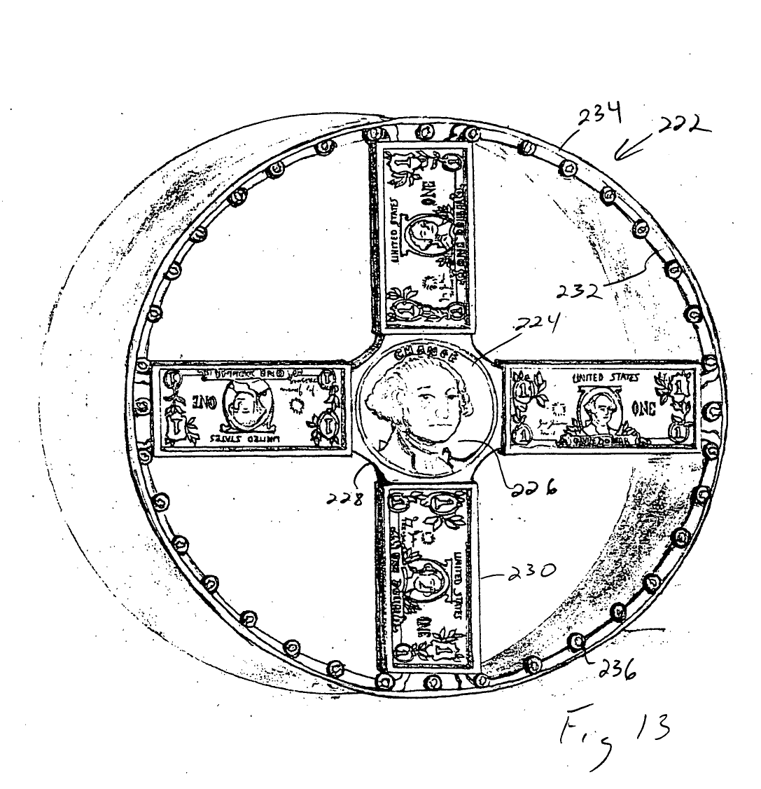

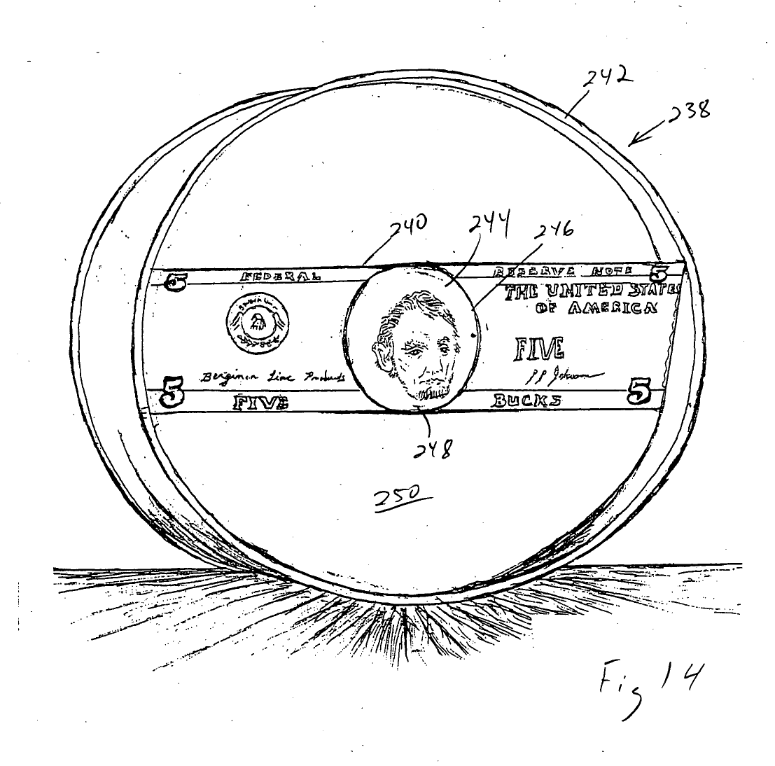

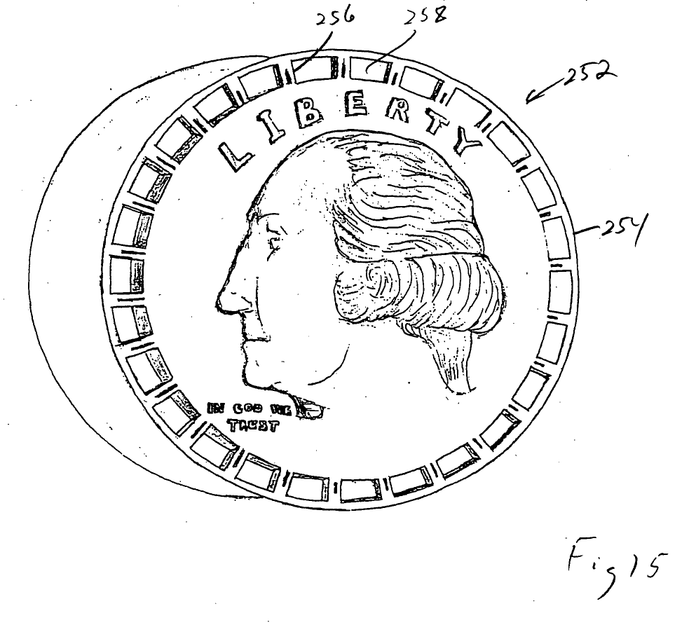

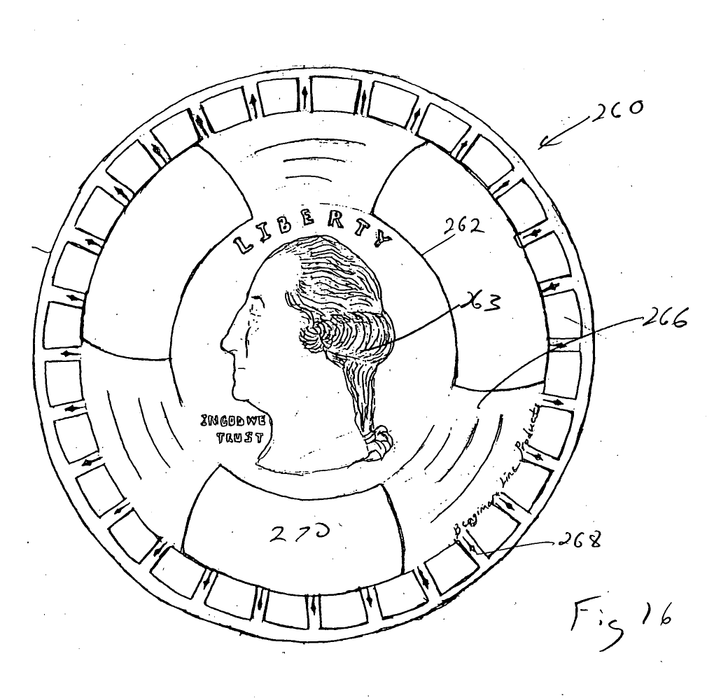

FIG. 6 shows a wheel 84 having a hub 86 with a portrait of Benjamin Franklin 88 formed thereon, which may include the portrait of Benjamin Franklin similar to that appearing on a present-day U.S. one-hundred dollar currency note. A circular, ridged border ring 90 is centered on the hub and surrounds the portrait. Extending from the hub 86 are six radially extending beams or spokes 92 for supporting a rim 94. The number of spokes 92 may vary, however. Formed on the outer face of each spoke 92 is a dollar sign 96 having a length that may be about less than half the diameter of the hub 86, and which is generally located along the midsection of the spoke 92. Two parallel, longitudinal cross bars 98, 100 of each dollar sign 96 extend beyond the ends of the S-portion of the dollar sign 96 and along the entire length of each spoke 92, from the hub 86 to the rim 94. A background or relief portion 102 extending across the width of each spoke 92 underlies the extended portions of the cross bars 98, 100 so that the spoke 92 has a generally fluted appearance. The outer face of the rim 94 is provided with a rim ring 104. The rim ring 104 is discontinuous where it intersects the spokes 92, so that it appears to be positioned behind or underlaying each spoke 92. Fastener heads 106, such as rivet, screw or bolt heads, which may only be ornamental and non-functional, may be provided along a circumferential center line of the rim ring 104. The fastener heads 106 are circumferentially spaced equally apart along the length of the rim ring 104 between each spoke 92. In the embodiment shown, there are five fastener heads 106 located on the rim ring 104 between each spoke, although this number may be less or more.

Referring to FIG. 7, a wheel 108 having a hub 110 with a side-profile portrait 112 of George Washington on its outer face is shown. The portrait 112 may be the same or substantially similar to that of a present-day U.S. quarter-dollar coin. A circular border ring 113 centered on the hub 110 surrounds the portrait 112. Radially extending from the hub are five circumferentially and evenly-spaced dollar signs 114 that extend generally from the hub 110 to a rim ring 116 of the rim 118. Parallel dollar sign longitudinal cross bars 120 merge with the border ring 113 and rim ring 116 to provide a generally continuous or non-broken surface. The dollar signs 114 may comprise spokes of the wheel 108, with the areas 122 between the spokes being open. Alternatively, the dollar signs 114 may be in the form of relief or etching on a background surface or relief plane designated by the area 122.

FIG. 8 illustrates a wheel 124 having a portrait of Benjamin Franklin 126, which may be the same or similar to the portrait of Benjamin Franklin as he appears on a present-day U.S. one-hundred dollar currency note, formed and centered on the outer face of the hub 128. Surrounding the portrait 126 is a ridged border ring 130. Four beams or spokes 132 extend from the hub 128 to the rim 134 of the wheel 124, which are generally perpendicular to the next adjacent spoke 132. The spokes 132 are formed from a radially extending trunk portion 136, which is joined to and extends from the hub 128, and a bill portion 138 opposite the hub 128, which is joined and merges with the rim 134. The trunk 136 has a generally uniform width, which is generally less than the diameter of the hub 128, as is shown. The length of the trunk 136 may be one or more times greater than the hub diameter.

Formed on the outer surface of the trunk portion 136 are parallel flute-like bars 140, giving the trunk 136 the appearance of a classical architectural column. The bill portion 138 may have a width that is greater than the width of the trunk 136, and may be one or more times greater than the diameter of the hub 128. The bill portion 128 is generally configured to appear as substantially the entire face of a rectangular currency note, with the length of the note being generally perpendicular to the length of the trunk 136. In the embodiment shown in FIG. 8, the bill portion is the front face of a U.S. one-hundred dollar bill containing the portrait 142 of Benjamin Franklin. The bill portion 128 may be oriented either with the bottom of the portrait 142 facing toward the rim 134 or facing the trunk 136. When facing the trunk 136, the bill portion 128 appears as the base of the column formed by the fluted trunk 136. Alternatively, with the bottom of the portrait facing the trunk 136, the bill portion 128 would appear as the capital of the column formed by the trunk 136. The area of the bill portion 128 abutting the rim 134 is flared outward to provide a smooth curved portion 144 on either side where the bill portion 128 joins the rim 134.

FIG. 9 shows a wheel 146 having spokes in the form of four pairs of opposite facing dollar signs 148, 150 that are evenly and circumferentially spaced apart and extend radially from a central hub 152. The curved portion 154 of the S-portion of the dollar sign 148, 150 adjacent to the hub 152 of each facing pair is in a touching or near touching relationship. Additionally, the terminal end 56 of the dollar sign 148, 150 of each adjacent pair joins or is touching the other next adjacent dollar sign. The dollar signs 148, 150 extend radially along their lengths from the hub 152 to a rim ring 158 of the rim 160. The ends of each dollar sign 148, 150 adjacent to the rim 160 are spaced apart or in a non-touching relationship.

Referring to FIG. 10, a wheel 158 is shown having an image 160, including a side-profile portrait of George Washington, which may be the same or similar to the entire face appearing on a present-day U.S. quarter-dollar coin, on the outer face of the hub 162. Underlaying or appearing to underlay the image 160 of the hub 162 are two dollar signs 164, 166, which are centered on the hub 162 and have longitudinal axes that are perpendicular to one another so that the dollar signs appear in a crossed pattern. The dollar signs 164, 166 may form support beams or spokes of the wheel 158. Each dollar sign 164, 166 extends across substantially the diameter of the wheel 158 to the rim 168 at its outer facing rim ring 170. The width of the dollar signs 164, 166 may be two or more times greater than the width of the coin image 160. The width of the S-portion of each dollar sign 164, 166 where it underlays the coin portion 160 may be generally equal to the width or diameter of the coin 160 or hub 162. The curved body of the S-portion may gradually taper or narrow in width slightly toward the ends, as is shown. The dollar signs 164, 166 each have two longitudinal, parallel cross bars 172, 174, which are centered on and overlay or generally appear to overlay the S-portion of each dollar sign 164, 166. The cross bars 164, 166 generally extend the entire length of the dollar signs 164, 166 and may be spaced apart a distance equal to about half the width of each dollar sign 164, 166.

The inner curved body portion 176 of each S of the dollar signs 164, 166 is configured so that it overlays or appears to overlay the outer body portion 178 of the S of other dollar sign. This provides an interlaced appearance where the S's of the dollar signs 164, 166 intersect one another at their midsections.

Each cross bar 172, 174 is composed of two abutting parallel bar members 180, 182. As viewed in FIG. 10, the right bar member 182 extends downward from the rim 168 and merges with an arcuate outer quarter-ring portion 184 surrounding the coin image 160 on the hub 162. The left bar member 180 of each left cross bar extends downward from the rim 168 until it intercepts the S-portion of the dollar sign on which it is overlaid or the arcuate quarter-ring portion 184. The member 180 terminates at this point, appearing to pass behind the S-portion or arcuate portion 184. Continuing downward as viewed in FIG. 10, the bar members 180, 182 begin again at the point 186 just beyond the next adjacent right cross bar 174, appearing to pass through the surface of the S-portion from below, and continue to extend non-interrupted toward the rim 168, overlaying the S-portion, as is shown. The design for each cross bar 172, 174 is generally the same, with the left cross bar 172 being an inverted image of the cross bar 174 rotated 180 degrees. The four arcuate quarter-ring portions 184 formed on the hub together provide a ridged border ring structure surrounding the coin image 160. The ends of the S-portion may terminate in flat edges 186 that may be generally perpendicular to the corresponding cross bars 172, 174 or longitudinal axis of the dollar sign.

FIG. 11 illustrates a wheel 188 having a circular hub 190 with a plurality of beams or spokes 192 radiating outward from the hub 190. The spokes 192 are formed from nine rectangular currency notes, which may be in the form of a portion of a front face that is the same or similar to a present-day twenty-dollar U.S. currency note. The currency note is shown having an image or portrait of Andrew Jackson, as well as the designation “20” or “twenty dollars” to indicate its denomination. Alternatively, different currency notes or different faces of the same currency note could be used. The orientation of each note may be varied as well. These may be repeated, alternated or different currency note faces may each comprise a different spoke of the wheel.

As shown, each currency note 192 has its bottom edge generally aligned along radially extending lines spaced about every 40 degrees and extending from the center of the hub 190, so that the length of the bill 192 extends radially from the hub 190. The bills 192 are of sufficient length and size so that if the entire face of the bill were completely shown or exposed, the lower left hand corner (as shown in FIG. 11) would be centered on the center of the hub, and the opposite or right hand corner would extend to the rim or near the rim 194. The circular hub or hub plate 190 may be plain (as shown) with no design or indicia formed thereon, or it may have a portrait, symbol or indicia, which may be monetary indicia or otherwise. The hub plate 190 covers or appears to cover that portion of each bill 192 that would otherwise coextend with the hub portion 190. In this way the bills 192 appear to radially extend from behind the hub portion 190. The upper left hand portion of each bill 192 is shown to appear overlapped by the next adjacent bill 192 in the counter-clockwise direction around the hub. This may be varied, however. For example, the lower right hand portion of each bill 192 could be overlapped by the next adjacent clockwise bill. The right edge of each bill 192 overlaps or appears to overlay an inner rim ring 196. Surrounding the rim ring 196 and the ends of the bills 192 is an outer rim ring 198 on the outer face of the rim 194. Openings or relief areas 200 may be provided between the bills 192.

FIG. 12 shows a wheel 202 having four spokes or beams 204 extending from a central hub 206. The spokes 204 are in the form of an entire front face of a rectangular currency note. In the embodiment shown, the entire front face portion of a present-day fifty-dollar U.S. currency note is used, including a portrait of Ulysses S. Grant and the designation “50” or “fifty” to indicate its denomination. Different currency note faces may be used, as well. The hub portion 206 is shown as being generally square in configuration, with the corners 208 of the square being flattened or beveled at approximately 45 degree angles with respect to the sides 210 of the square. The length of the beveled areas 208 may be approximately one-half the length of each side edge 210 of the hub. Located on the outer face of the hub 206 are four dollar signs 212 positioned generally adjacent to the corners 208, with the length of each dollar sign 212 being generally perpendicular to its corresponding flat corner 208. The width of each dollar sign 212 may be less than the length of the corner 208.

As shown, the left side edge of each bill 204 abuts and coextends with one of the side edges 210 of the hub portion 206. The bills 204 extend radially outward and terminate along the opposite side edge adjacent to a circumferential rim ring 214 on the outer face of the rim 216. Four secondary spokes or beams 218 are also provided that extend radially from the beveled corners 208 to the rim ring 214. The secondary spokes are generally rectangular in configuration and have a generally uniform width, with the width of each spoke 218 coextending with the length of its corresponding corner 208. The spokes 218 are shown without indicia, although they may have monetary indicia or otherwise. Openings or background relief areas 220 may be provided between the spokes 204, 218.

Referring to FIG. 13, a wheel 222 having a central hub portion 224 with a portrait 226 centered thereon is illustrated. The portrait 226 shown is that of George Washington, as it may appear or that appears similar to that on a present-day one-dollar U.S. currency note. The hub portion 224 is generally square in configuration with the corners being truncated as concave arcuate portions 228 of constant or varying radius.

Extending from the sides of the square hub portion 224 are spokes 230. The spokes 230 appear in the form of the entire face of a rectangular currency note with the side edge of the note abutting against a side of the square hub 224. In the embodiment shown, each of the spokes appears as an entire front face of a present-day U.S. one-dollar bill, although the faces may vary. The notes 230 extend radially lengthwise from hub 224 to a circumferential rim ring 232 of wheel rim 234. Formed on the rim ring 232 are circumferentially and evenly spaced apart coin faces 236, which may be the same or similar to a present-day U.S. quarter dollar or other coinage.

FIG. 14 shows a wheel 238 having a single rectangular currency note face 240 extending substantially across the entire diameter of the wheel 238 from opposite sides of the rim 242, with its longitudinal axis passing through the center of the hub. The currency note shown is the same or similar to a present-day U.S. five-dollar currency note, including a portrait 244 of Abraham Lincoln surrounded by a circular or oval border ring 246, which forms or overlays the hub or a portion of the hub 248. Relief planes or open areas 250 may be provided on or within the remaining support structure of the wheel 238.

FIG. 15 illustrates a wheel 252 wherein substantially the entire outer face of the wheel appears as a circular coin face. In the embodiment shown, the coin face is that of a present-day U.S. quarter dollar, including a side-profile portrait of George Washington centered on the hub and the words “Liberty” and “In God We Trust,” in proportion to and in relative position as they may be found on an actual front face of a present-day U.S. quarter dollar coin. Adjacent or near the rim 254 are a plurality of radially extending rectangular spokes 256 having a length that may be less than 1/10^{th} the diameter of the coin face portion and that are spaced apart a similar distance. The width of the spokes 256 may be about one half of the length of each spoke, but may vary. Rectangular or trapezoidal openings or raised or recessed relief areas 258 are positioned between the spokes 256.

A wheel 260 similar to the wheel 252 of FIG. 15, is shown in FIG. 16. The wheel 260 has a coin face portion 262 that is smaller in diameter and is centered on the hub 263, with the perimeter of the coin portion spaced radially apart a substantial distance from the rim 264 compared to that of FIG. 15. Three equally spaced apart radially extending spokes 266, which flare outward in width from the perimeter of the coin portion 262, join a circumferential spoked rim portion 268, which is generally similar to that described with respect to wheel 252 of FIG. 15. Open or relief areas 270 are positioned between the spokes 266.

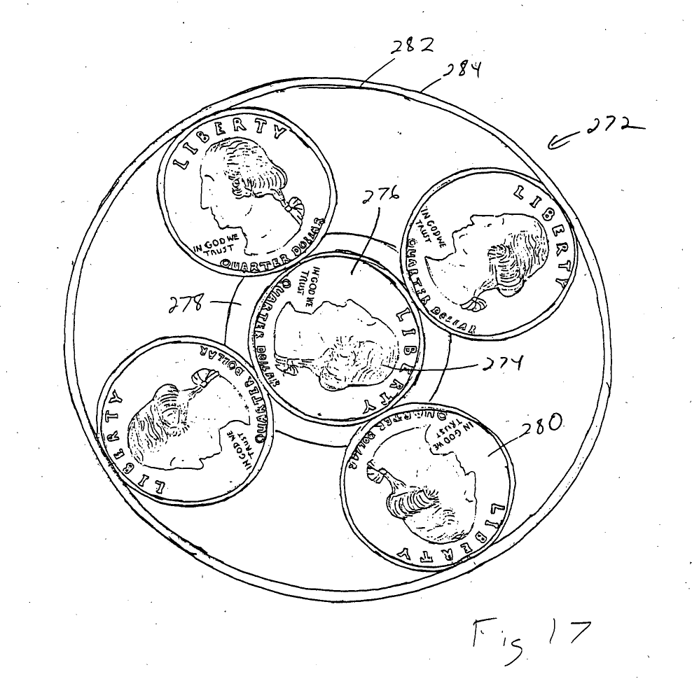

FIG. 17 shows a wheel 272 having a hub portion 274 with an outer face having a circular coin face 276 centered thereon. The coin face 276 is that of a front face of a present-day U.S. quarter dollar. A circular border ring 278 surrounds the coin face 276. Formed or appearing as spokes or beams of the wheel 272 are four coin faces 280. The coin faces 280 may be of the same diameter or size as the coin face 276 and are spaced with their centers located along radially extending lines that are approximately 90 degrees apart. The coin faces 280 each join or abut along one edge against the center coin face 276 and overlay or appear to overlay the border ring 278. The opposite edge of the coin faces 280 abut or join a rim ring 282 of the rim 284 of the wheel 272.

The present invention provides a decorative or customized wheel for use with an automotive vehicle. The wheels may be provided as after market wheels that present a more unique and individualized appearance than is usually presented with the original wheels, typically provided by the vehicle or original-equipment manufacturer. The monetary indicia provides a unique and individualized appearance to the wheel and to the automobile on which the wheel is employed. This may be desirable to many who want to convey a certain image or impression, particularly one associated with wealth or monetary success. It may also hint or suggest to those perceiving the wheel that the wheel may be of particular high cost or value, which is often the case for many customized wheels.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

1. A wheel for an automotive vehicle comprising:
a hub for mounting to an axle of the automotive vehicle;
a rim disposed radially outward from the hub and being configured for receiving a tire;
a support structure extending between the hub and the rim; and
wherein the hub, rim and support structure each have an outer face, the outer face of at least one of the hub, rim and support structure having formed thereon monetary indicia.

2. The wheel of claim 1, wherein:
the monetary indicia is selected from a group consisting of a portrait, a monetary value, a monetary symbol, and a word or phrase.

3. The wheel of claim 1, wherein:
the monetary indicia includes a portrait that is generally centered on the hub.

4. The wheel of claim 1, wherein:
the monetary indicia includes substantially the entire face of a coin that is centered on the hub.

5. The wheel of claim 1, wherein:
the monetary indicia includes substantially the entire face of a currency note that is oriented so that the currency note extends generally radially outward from the hub along the note's length.

6. The wheel of claim 1, wherein:
the monetary indicia includes substantially an entire face of one of a currency note and coin.

7. The wheel of claim 1, wherein:
the hub includes a removable hub plate and wherein the monetary indicia or a portion thereof is formed on the hub plate.

8. The wheel of claim 1, wherein:
different monetary indicia are formed on a combination of at least two of the hub, rim and support structure.

9. The wheel of claim 1, wherein:
monetary indicia are formed on each of the hub, rim and support structure.

10. The wheel of claim 1, wherein:
the monetary indicia are repeated and spaced circumferentially spaced apart on the wheel.

11. A wheel for an automotive vehicle comprising:
a hub for mounting to an axle of the automotive vehicle;
a rim disposed radially outward from the hub and being configured for receiving a tire;
a support structure extending between the hub and the rim; and
wherein the hub, rim and support structure each have an outer face, the outer face of at least two of the hub, rim and support structure having formed thereon monetary indicia.

12. The wheel of claim 11, wherein:
different monetary indicia is formed on the at least two of the hub, rim and support structure.

13. The wheel of claim 12, wherein:
the monetary indicia is selected from a group consisting of a portrait, a denomination value, a monetary symbol, and a word or phrase.

14. The wheel of claim 13, wherein:
one of the different monetary indicia formed on one of the at least two of the hub, rim and support member is selected from a group of indicia consisting of a portrait of a likeness selected from a group consisting of George Washington, Abraham Lincoln, Thomas Jefferson, Alexander Hamilton, John F. Kennedy, Andrew Jackson, Ulysses S. Grant, Benjamin Franklin, Franklin D. Roosevelt, William McKinley, Grover Cleveland, James Madison, Salmon P. Chase, Woodrow Wilson, Susan B. Anthony and Sacajawea, and the other of the different monetary indicia formed on the other of the at least two of the hub, rim and support member is selected from the group of indicia consisting of a denomination value, a monetary symbol, and a word or phrase.

15. The wheel of claim 11, wherein:
the hub includes a removable hub plate and wherein the monetary indicia or a portion thereof is formed on the hub plate.

16. The wheel of claim 11, wherein:
monetary indicia are formed on each of the hub, rim and support structure.

17. The wheel of claim 11, wherein:
the monetary indicia are repeated and spaced circumferentially spaced apart on the wheel.

18. A wheel for an automotive vehicle comprising:
a hub having a removable face plate for mounting to an axle of the automotive vehicle;
a rim disposed radially outward from the hub and being configured for receiving a tire;
a support structure extending between the hub and the rim; and
wherein the hub, rim and support structure each have an outer face, the outer face of at least two of the hub, rim and support structure having formed thereon monetary indicia selected from a group consisting of a portrait, a denomination value, a monetary symbol, and a word or phrase.

19. The wheel of claim 18, wherein:
the monetary indicia includes a portion of the face of a coin.

20. The wheel of claim 18, wherein:
the monetary indicia includes a portion of the face of a currency note.

21. The wheel of claim 18, wherein:
the monetary indicia includes a face of a currency note that is oriented with the currency note extending generally radially outward from the hub along the note's length.
